(19) United States
(12) Patent Application Publication
(10) Pub. No.: US 2014/0176306 A1
(43) Pub. Date: Jun. 26, 2014

(54) NEAR-FIELD-COMMUNICATION (NFC) ENABLED MOBILE DEVICE AND OPERATION METHOD THEREOF

(71) Applicant: Pantech Co., Ltd., Seoul (KR)

(72) Inventors: So-Hyun LEE, Seoul (KR); Sang-Hwa Lee, Seoul (KR)

(73) Assignee: Pantech Co., Ltd., Seoul (KR)

(21) Appl. No.: 14/134,609

(22) Filed: Dec. 19, 2013

(30) Foreign Application Priority Data
Dec. 20, 2012 (KR) 10-2012-0149276

(51) Int. Cl. H04B 5/00; G06K 7/10

(52) U.S. Cl. CPC H04B 5/0056; G06K 7/10009
USPC 340/10.1

(57) ABSTRACT

A method for Near Field Communication (NFC) communications and an NFC-enabled device are disclosed. The method includes sensing an induced current in a Near Field Communication (NFC) antenna; and switching a switch on and off to start and stop the flow of the induced current in the NFC antenna.

### CROSS-REFERENCE TO RELATED APPLICATION

This application claims priority from and the benefit under 35 U.S.C. §119(a) of Korean Patent Application No. 10-2012-0149276, filed on Dec. 20, 2012, which is hereby incorporated by reference for all purposes.

### BACKGROUND

1. Field

The following description relates to a mobile Near-Field-Communication (NFC)-enabled device, and more particularly, to a mobile NFC-enabled device and an operation method thereof.

2. Description of the Background

A near field communication (NFC) is a type of peer-to-peer (P2P) short-range communication technology, which allows exchange of various types of wireless data within a very short distance. The current NFC allows communications within a distance of a few centimeters using the frequency band of 13.56 megahertz (MHz). Further P2P short-range communication technologies include Bluetooth®, Wi-Fi Direct®, Zigbee®, and the like. NFC has a limited transmission capacity and narrower communication range compared to the other P2P short-range communication technologies, but is more secure and can be implemented at a low cost.

Recent smartphones equipped with Android® operating system (OS) have NFC chips embedded therein to allow use of NFC technology, and it is anticipated that smartphones equipped with other OSs, such as, Apple's iOS®, will have NFC chips embedded within the coming hardware generations. Such a device equipped with an NFC chip thereby enabling to communicate with other devices (for example, an NFC reader or other mobile devices with an NFC capability) through an NFC scheme is referred to as an NFC-enabled device. An “NFC tag” indicates a passive device that stores data readable by an NFC-enabled device or an NFC reader.

The NFC-enabled device has three operation modes including reader/writer mode, peer-to-peer mode and Card Emulation (CE) mode. An NFC-enabled device operating in CE mode appears to an external NFC reader as being similar to a contactless smart card. Hence, the usage of the NFC-enabled device varies depending on data stored in the NFC tag read by the NFC reader. For example, the NFC-enabled device is utilized for contactless payment, ticketing, identification card, a membership card, and the like, depending on information contained in the NFC tag.

As the usages of the NFC-enabled device have diversified, the number of NFC tags equipped or stored in one NFC-enabled device increases. Moreover, a user can store one or more desired NFC tags to use in the NFC-enabled device, such as, a smartphone. For example, to use as a travel card, the user includes an NFC tag containing data required for operating as a travel card in the NFC-enabled device. In addition, the user stores an NFC tag containing data required for operating as a credit card in the NFC-enabled device. The user includes an NFC tag containing data of ticketing information or mobile coupon information in the NFC-enabled device.

However, in order to operate the NFC-enabled device in CE mode, which stores a number of NFC tags, it is prerequisite that the user previously selects an NFC tag to use. The user executes an application to select the desired NFC tag for a particular purpose in advance to use the NFC-enabled device including a number of NFC tags. In addition, to change an NFC tag to use, the user also needs to execute an application to select another NFC tag.

### SUMMARY

Exemplary embodiments of the present invention provide a mobile NFC-enabled device and an operation method thereof.

Additional features of the invention will be set forth in the description that follows, and in part will be apparent from the description, or may be learned by practice of the invention.

Exemplary embodiments of the present invention disclose a method including: sensing an induced current in a Near Field Communication (NFC) antenna; and switching a switch on and off to start and stop the flow of the induced current in the NFC antenna.

Exemplary embodiments of the present invention disclose an NFC-enabled device including: a Near Field Communication (NFC) antenna configured to sense an induced current therein; and a switch configured to start and stop the flow of the induced current in the NFC antenna.

Exemplary embodiments of the present invention disclose a non-transitory computer readable medium comprising an executable program which, when executed, performs a method for connecting a device and a user terminal, the method comprising: sensing an induced current in a Near Field Communication (NFC) antenna; and switching a switch on and off to start and stop the flow of the induced current in the NFC antenna.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a diagram illustrating a configuration of a mobile NFC-enabled device according to exemplary embodiments of the present invention.

FIG. 2 is a diagram illustrating a configuration of a CE mode operation unit according to exemplary embodiments.

FIG. 3 illustrates an NFC unit according to exemplary embodiments of the present invention.

FIG. 4A, FIG. 4B and FIG. 4C are diagrams illustrating a configuration and operation of a controller switch of an NFC antenna in an NFC unit according to exemplary embodiments. FIG. 4A illustrates a control switch when the mobile NFC-enabled device operates in reader/writer mode or peer-to-peer mode according to exemplary embodiments. FIG. 4B and FIG. 4C illustrate control switches when the mobile NFC-enabled device operates in CE mode according to exemplary embodiments.

FIG. 5 illustrates a method to operate a mobile NFC-enabled device according to exemplary embodiments of the present invention.

FIG. 6 illustrates a method to operate a mobile NFC-enabled device according to exemplary embodiments of the present invention.

FIG. 7 illustrates a method of a mobile NFC-enabled device according to exemplary embodiments of the present invention.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art. It will be understood that for the purposes of this disclosure, “at least one of X, Y, and Z” can be construed as X only, Y only, Z only, or any combination of two or more items X, Y, and Z (e.g., XYZ, XZ, XYY, YZ, ZZ). Throughout the drawings and the detailed description, unless otherwise described, the same drawing reference numerals are understood to refer to the same elements, features, and structures. The relative size and depiction of these elements may be exaggerated for clarity.

The terminology used herein is for describing particular embodiments only and is not intended to be limiting of the present disclosure. As used herein, the singular forms “a,” “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first,” “second,” and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. Although some features may be described with respect to individual exemplary embodiments, aspects need not be limited thereto such that features from one or more exemplary embodiments may be combinable with other features from one or more exemplary embodiments.

In addition, embodiments described in the specification are wholly hardware, and may be partially software or wholly software. In the specification, “unit”, “module”, “device”, “system”, or the like represents a computer related entity such as hardware, combination of hardware and software, or software. For example, in the specification, the unit, the module, the device, the system, or the like may be an executed process, a processor, an object, an executable file, a thread of execution, a program, and/or a computer, but are not limited thereto. For example, both of an application which is being executed in the computer and a computer may correspond to the unit, the module, the device, the system, or the like in the specification.

Embodiments described herein may apply to a mobile near-field-communication (NFC)-enabled device. The mobile NFC-enabled device is a mobile device equipped with an NFC chip to communicate with another device (e.g., another NFC device or an NFC reader) through a NFC process. The mobile NFC-enabled device may generally operate in a mode including reader/writer mode, peer-to-peer mode, and card emulation mode. The exemplary embodiments described herein may generally apply, without limitation, to the mobile NFC-enabled device that operates in Card Emulation (CE) mode. Thus, the exemplary embodiments described herein may apply in the same manner to mobile devices that may not support all operations performed in the above three modes but are compatible with at least the CE mode.

An “NFC tag” includes a passive medium to store data readable by another NFC device or an NFC reader. The mobile NFC-enabled device operating in CE mode may be recognized by other NFC devices or an NFC reader as being similar to a contactless smart card, and the NFC tag can be considered as a group of data (hereinafter, referred to as “NFC tag data”) enabling the device to operate as a contactless smart card. The NFC tag data may include all types of data that can be stored in a standardized NFC tag, including, for example, mobile card (e.g., a travel card or a credit card) data, identification data, such as, a barcode, and authentication data, such as, ID card, for access control or authentication of members of buildings, such as, schools, firms, organizations and apartments. The “NFC reader” indicates a device that is capable of receiving and reading an NFC tag and NFC tag data. Aspects of the invention are not limited to a dedicated device for reading an NFC tag, such that any type of devices capable of reading an NFC tag may be the NFC reader.

A “secure element (SE) domain” includes a particular domain defined in a storage unit of the mobile NFC-enabled device to store the NFC tag and the NFC tag data, and to be transmitted to the external NFC reader. The SE domain does not need to be a physically partitioned area, and may be a logical portion of the storage unit where the NFC tag to be transmitted to the NFC reader through an NFC scheme is loaded or NFC tag data is written and stored. The SE domain may be stored in a storage unit, such as, a universal subscriber identity module (USIM), but the aspects of the invention are not limited thereto.

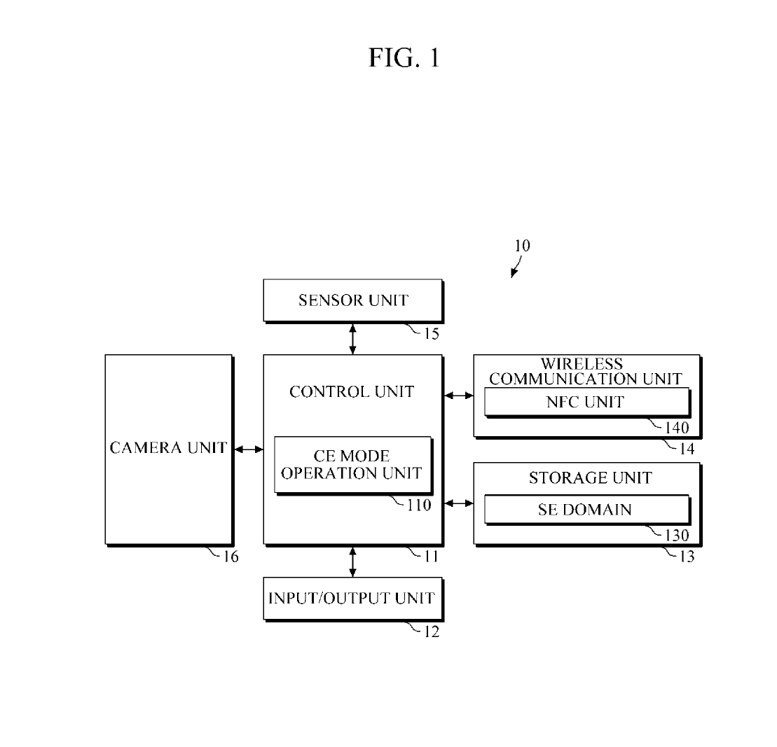

FIG. 1 is a diagram illustrating a configuration of a mobile NFC-enabled device according to exemplary embodiments of the present invention. The mobile NFC-enabled device 10 shown in FIG. 1 may be a smartphone, a tablet computer, or other device, which is equipped with an NFC chip to provide NFC capability. Referring to FIG. 1, the mobile NFC-enabled terminal 10 may include a control unit 11 with a card emulation (CE) mode operation unit 110, an input/output unit 12, a storage unit 13 including a secure element (SE) domain 130 defined therein, a wireless communication unit 14 with an NFC unit 140, a sensor unit 15, and a camera unit 16. Here, the CE mode operation unit 110 is an exemplary unit that enables the mobile NFC-enabled device 10 to operate in CE mode, such that an external NFC reader recognizes the mobile NFC-enabled device 10 as a non-contact smart card.

The configuration of the mobile NFC-enabled device 10 illustrated in FIG. 1 is an exemplary configuration of a mobile electronic device with an NFC capability. Aspects of the invention are not limited thereto, such that the mobile NFC-enabled device may not illustrate all units in FIG. 1 and may omit one or more units. For example, the mobile NFC-enabled device may not include the sensor unit 15 and/or the camera unit 16. The mobile NFC-enabled device may further include additional units necessary for its operation, and the additional units may differ according to the type or operation of the mobile NFC-enabled device 10. For example, the mobile NFC-enabled device 10 may further include, without limitation, at least one of a vibration generation module, a global positioning system (GPS) module, a digital multimedia broadcasting (DMB) reception module, a wired communication module, a power supply, and the like.

The control unit 11 may perform overall management, processing, and control for the operation of the mobile NFC-enabled device 100. For example, the control unit 11 may control the wireless communication unit 14 to enable the mobile NFC-enabled device 10 to communicate with a server or another mobile device for performing video/voice calling operation or wireless data transmission/reception, and may process received signals and signals to be transmitted. The control unit 11 may perform control of operation or signal processing in an effort to execute a module or a program for running games, playing multimedia content, or executing an application. The control unit 11 may perform a predefined process in response to a visual, audible, or mechanical input signal received from the input/output unit 12 or from the sensor unit 15. The control unit 11 may control the input/output unit 12 to output a result of processing the input signal and/or an execution result of the control unit 11 as a visual, audible, or mechanical signal.

The control unit 11 may perform control for the operation of the mobile NFC-enabled device 10 in CE mode. For example, in response to the NFC unit 140 detecting a magnetic field from the external NFC reader, the control unit 11 may control the NFC unit 140 to transmit at least one of the NFC tags stored in the storage unit 13 to an external unit, like the NFC reader. The control unit 11 may actively select one or more pieces of NFC data to be transmitted to the external unit, from all or some of the NFC tags stored in the storage unit 13 according to a process, which will be described later, and load the selected data in the SE domain 130.

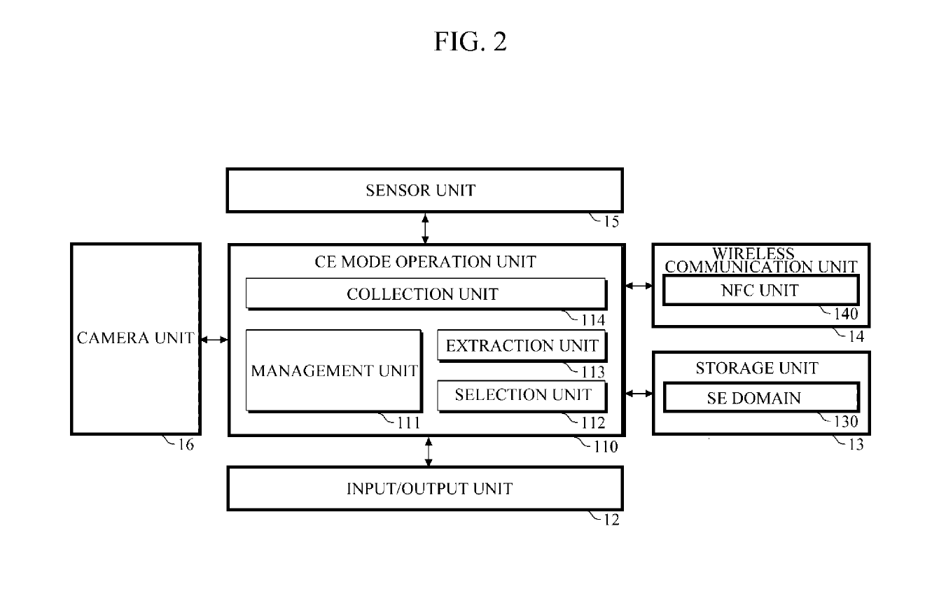

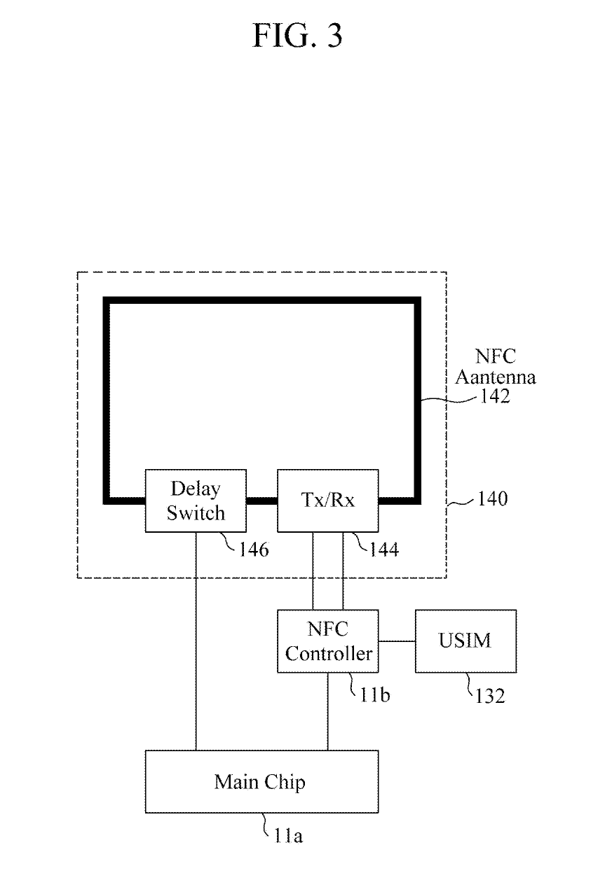

The control unit 11 may include the CE mode operation unit 110 to operate the mobile NFC-enabled device 10 in CE mode. In response to the NFC unit 140 detecting a magnetic field from the external NFC reader, the CE mode operation unit 110 may load the NFC tags stored in the storage unit 13 into the SE domain 130. At this time, the control unit 11 may load all or some of the NFC tags present in the storage unit 13 one by one into the SE domain 130. As described later, this process of the control unit 11 (i.e., loading the NFC tags one by one into the SE domain 130) may be performed when the NFC unit 140 can continuously monitor the magnetic field from the NFC reader, that is, while the NFC unit 140 is detecting the magnetic field. The NFC tags may be loaded under the control of the control unit 11 in response to an internally predefined control signal or in association with by turning off and on an induced current periodically or in response to a control signal by a predetermined switch, for example, a delay switch (refer to FIG. 3) connected to an NFC antenna of the NFC unit 140, wherein the induced current flows through the NFC antenna. The CE mode operation unit 110 may control the NFC unit 140 to transmit the NFC tags loaded into the SE domain 130 to the external unit. The operation and configuration of the CE mode operation unit 110 will be described in detail later with reference to FIG. 2.

The input/output unit 12, which constitutes a user interface (UI) of the mobile NFC-enabled device 10, may include an input module to enable the user to input user data, an input signal, an instruction, a request signal, and the like, and an output module to output a result of processing data, information and signal from the mobile NFC-enabled device 10. The input module may be a microphone to input voice or sound through, a keypad, a dome switch, buttons, a jog wheel, a touch panel, and the like by which to input data and instructions to the mobile NFC-enabled device 10. In addition, the output module may include a display through which to output an image signal or a video signal, an audio output unit, such as, a speaker and/or an ear jack, through which to output an audio signal, and a vibration module to output a mechanical signal (e.g., vibration).

Further, the mobile NFC-enabled device 10 may include a touch screen as the input/output unit 12. The touch screen, as a UI for interaction between a user and the mobile NFC-enabled device 10, may act as both a touch panel performed as an input module and a display performed as an output module. The touch screen may have a stacked structure in which the touch panel as an input unit and the display as an output unit are coupled to each other, or have an integrated structure in which the touch pad and the display may be integrated into one device. The user may touch, directly or with a stylus pen, the touch screen to input an instruction or information to the mobile NFC-enabled device 10. The mobile NFC-enabled device 10 may output information, such as, text, an image, and/or video through the touch screen, enabling the user to view the output information.

In one aspect of the present invention, the CE mode operation unit 110 may provide a predetermined UI via the input/output unit 12 to enable interaction between the mobile NFC-enabled device 10 and the user when the mobile NFC-enabled device 10 operates in CE mode. For example, the CE mode operation unit 110 may provide the UI via the input/output unit to allow the user to register or delete one or more NFC tags, prioritize registered NFC tags, set different conditions for selecting each registered NFC tag, and/or choose NFC tags to be loaded into the SE domain 130.

The storage unit 13 may store applications and data for execution and operation of the mobile NFC-enabled device 10. The storage unit 13 may store a variety of computer programs, such as, OS programs, module programs, and application programs, for the control and management of the control unit 11. Additionally, the storage unit 13 may store data and information, such as, e-mails, text, images, videos, documents, music files, phone numbers, call history, and messages. The storage unit 13 may include various types of storage, and may include random access memory (RAM), internal or external flash memory including USIM memory, magnetic-disk memory, and read only memory (ROM), without limitation.

The storage unit 13 may store one or more NFC tags installed by the user, along with the programs to enable the mobile NFC-enabled device 10 to operate in CE mode. The storage unit 13 may store information about the registered NFC tags, priority information of the NFC tags, selection information with respect to each NFC tag, usage history of each NFC tag, and/or information about the usage of NFC tags by time and place. The storage unit 13 may store the SE domain 130 in a physical and/or logical area to which an NFC tag to be transmitted from the mobile NFC-enabled device 10 in CE mode to the NFC reader through an NFC technique is loaded or recorded.

The wireless communication unit 14 may allow the mobile NFC-enabled device 10 to communicate with a wireless communication network and/or another electronic device by transmitting and receiving radio waves. The wireless communication unit 14 may perform communication according to one or more wireless communication protocols. The wireless communication unit 14 may not be limited in type or number. For example, the wireless communication unit 14 may include a mobile communication unit for voice, video and/or data communication in accordance with mobile communication standard, and a Wi-Fi communication unit for communication over wireless LAN (WLAN). In addition, the wireless communication unit 14 includes the NFC unit 140 for near field communication with another mobile NFC-enabled device or an NFC reader. The NFC unit 140 may include an NFC antenna, through which an induced current flows by the effect of the magnetic field from the external unit (e.g., an NFC reader), and a transceiver (Tx/Rx).

The sensor unit 15 may include, for example, a gravity sensor, a proximity sensor, an acceleration sensor, a motion sensor, an illumination sensor. The camera unit 16 may obtain an image/video signal and may be included in exemplary embodiments. As will be described later, information collected by the sensor unit 15 and/or the camera unit 16 may be used to select NFC tags to be loaded into the SE domain 130.

In addition, the mobile NFC-enabled device 10 may include a power supply unit (not illustrated). The power supply unit provides all elements in the device 10 with power for operation of the mobile NFC-enabled device 10. The mobile NFC-enabled device 10 may include a battery as a power source, which is detachably or integrally attached thereto. However, aspects of the invention may not be limited thereto, such that the mobile NFC-enabled device 10 may include a module to be provided with power from an external power system.

FIG. 2 is a diagram illustrating a configuration of a CE mode operation unit according to exemplary embodiments. Referring to FIG. 2, the CE mode operation unit 110 may include a management unit 111, a selection unit 112, an extraction unit 113, and a collection unit 114. FIG. 2 illustrates an exemplary configuration of the CE mode operation unit 110 and aspects of the invention are not limited thereto. The CE mode operation unit 110 may not illustrate all units in FIG. 2, and may omit one or more modules or may include one or more additional units. The units of the CE mode operation unit 110 may be distinguished in terms of logical process, and each unit may be physically separated from other units or two or more units or may be physically integrated into one body. Further, each unit as a logical element of the CE mode operation unit 110 may be integrated into one unit.

The management unit 111 may perform overall management, processing, and control for the operation of the CE mode operation unit 110. The management unit 111 may transmit and receive signals to and from other units 12, 13, 14, 15, and 16 in the mobile NFC-enabled device 10 (refer to FIG. 1), or control the operation of these units. The management unit 111 may control the other units 112, 113, and 114 in the CE mode operation unit 110 to operate with one another, such that the mobile NFC-enabled device 10 can operate normally in CE mode.

For example, the management unit 111 may load an NFC tag into the SE domain 130, wherein the NFC tag is selected by the selection unit 112 from among all or some of the NFC tags stored in the storage unit 13. The selection unit 112 may select an NFC tag to be loaded into the SE domain 130 based on criteria, under the control of the management unit 111. In some embodiments, a user may select an NFC tag to be loaded into the SE domain 130 from among NFC tags displayed through the UI. In this case, the management unit 111 may control the operation of the extraction unit 113 and the input/output unit 12.

The management unit 111 may load a plurality of NFC tags one by one into the SE domain 130. The management unit 111 may load one or more NFC tags sequentially into the SE domain 130 in an arbitrary order or according to predefined criteria. Here, the “arbitrary order” may imply that all the NFC tags are loaded into the SE domain 130 in any order without omission, by, for example, a round-robin scheme. In addition, the “predefined criteria” may be previously set by a user or may be priorities which are given to the NFC tags in real time or which are determined by a process with reference to a diversity of information collected by the collection unit 114.

The management unit 111 may operate when the NFC unit 140 is able to continuously detect the magnetic field from the NFC reader, that is, when a stable communication between the mobile NFC-enabled device 10 (refer to FIG. 1) and the NFC reader is available. When the user continuously places the mobile NFC-enabled device 10 at a close vicinity to or within range of a NFC reader, without moving the device out of range from the NFC reader, (i.e., when the mobile NFC-enabled device is enabled to detect the magnetic field from the NFC reader), the management unit 111 may load a plurality of NFC tags one by one into the SE domain 130. Even when an event takes place in which the mobile NFC-enabled device fails to detect the magnetic field from the NFC reader because of an unexpected situation, for example, where the user moves the mobile NFC-enabled device away or out of range from the NFC reader and brings it back close to the NFC reader again, the management unit 111 may operate in the same manner as when the mobile NFC-enabled device continues to detect the magnetic field, as long as the failure lasts for a short period.

However, aspects of the invention may not be limited thereto, such that the operation of the management unit 111 may be implemented in various ways. For example, the operation of the management unit 111 may be implemented in a software manner according to internal operation mechanism (e.g., software designed to periodically load a plurality of NFC tags one by one into the SE domain 130 with a limited number of times. For example, the management unit 111 may be designed to operate in response to a given message (e.g., an NFC-tag receipt failure message) received from the NFC reader. This implementation of the management unit 111 may be possible only when a new NFC communication standard for specifying the transmission of such message is made available.

For example, the loading of the NFC tag may be achieved by providing the mobile NFC-enabled device 10 with the same effect as produced by placing it away from the NFC reader and then moving it closer or within range to the NFC reader again, even when the mobile NFC-enabled device 10 remains at a close vicinity to the NFC reader. Generally, when placed close to the NFC reader, the mobile NFC-enabled device 10 detects the magnetic field from the NFC reader, and by the effect of the magnetic field, an induced current is generated in the NFC antenna (not shown) of the NFC unit 140 and flows in it. In this case, the management unit 111 may recognize the approach of the mobile NFC-enabled device 10 to the NFC reader by detecting the flow of the induced current. In some examples, after detecting a new flow of the induced current, the management unit 111 may load a predetermined NFC tag, for example, an NFC tag selected by the selection unit 122 or by the user through the UI, into the SE domain 130.

When a conventional mobile NFC-enabled device remains close to the NFC reader, it may not be able to transmit an additional NFC tag because an induced current continues to flow in the NFC antenna. Therefore, by updating a flow of the induced current in the NFC antenna of the NFC unit 140, that is, by temporarily blocking the induced current flow and releasing the flow, the management unit 111 may be able to load a plurality of NFC tag one by one into the SE domain 130 even when the mobile NFC-enabled device 10 stays close to the NFC reader. At this time, while the mobile NFC-enabled device 10 stays at the same position close to the NFC reader, the flow of the induced current in the NFC antenna of the NFC unit 140 results in the same effect as produced when the mobile NFC-enabled device 10 is moved out from and then returns back within range of the NFC reader, so that the management unit 111 is able to allow other NFC tags to be transmitted through the NFC unit 140 by loading them into the SE domain 130. Aspects of the present invention are not limited to particular methods for temporarily blocking and restarting the flow of an induced current in an NFC antenna.

FIG. 3 illustrates an NFC unit according to exemplary embodiments of the present invention. FIG. 3 illustrates an example of a configuration of the NFC unit 140 that can temporarily block an induced current flowing in an NFC antenna and restart the flow. Referring to FIG. 3, the NFC unit 140 may include an NFC antenna 142, a transceiver (Tx/Rx) 144, and a switch 146. A main chip 11a and an NFC controller 11b may be included in the control unit 10 of FIG. 1, and a USIM 132 may be included in the storage unit 13.

In FIG. 3, the switch 146 is physically connected to the main chip 11a and is controlled by the main chip 11a. However, aspects of the invention are not limited thereto, such that the switch 146 may be connected to the NFC controller 11b and be controlled by the NFC controller 11b. In either case, the operation of the switch 146 may be logically controlled by the CE mode operation unit 110 (refer to FIGS. 1 and 2), more particularly, the management unit 111 (refer to FIG. 2).

The switch 146 may stop or start the flow of an induced current in the NFC antenna 142, the induced current being generated by magnetic field from an NFC reader. The switch 146 may be a delay switch. Referring to FIG. 3, the operation of the switch may be controlled by the main chip 11a, but aspects of the present invention are not limited thereto.

In the example of FIG. 2, the operation of the switch 146 may be controlled by the management unit 111. The management unit 111 may control the operation of the switch 146 to be synchronized with the loading of a new NFC tag into the SE domain 130. For example, the management unit 111 may perform synchronization by matching the time point at which the switch 146 is initially switched ON and the time point at which the first NFC tag is loaded, when a time interval between switch-OFF and switch-ON of the switch 146 is set to be the same as an interval at which to load an NFC tag into the SE domain. For example, the management unit 111 may transmit a signal around the time at which a flow of the induced current is switched ON again, to initiate an NFC tag to be loaded into the SE domain, or on the contrary, the management unit 111 may transmit a signal to the switch 146 around the time at which the NFC tag is loaded into the SE domain, so as to switch ON the switch 146 again.

The management unit 111 may control the switch 146 to stop operating when magnetic field from the NFC reader is not detected any longer, or when the mobile NFC-enabled device is moved away from the NFC reader. In this case, the management unit 111 may stop loading the remaining NFC tags. However, if the detection of the magnetic field has been interrupted and the detection is resumed within a predetermined period of time (for example, the user moves away the NFC tag from the NFC reader and returns it back close to the NFC reader), the management unit 111 may control to continue the above operation of the switch 146 and the loading of the synchronized NFC tags.

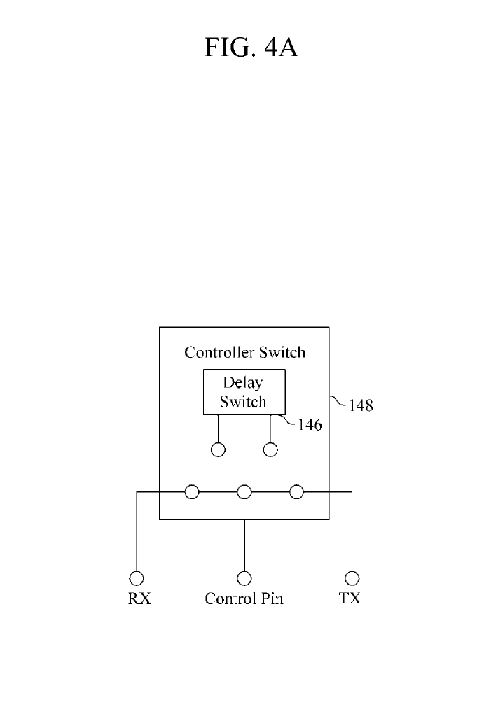

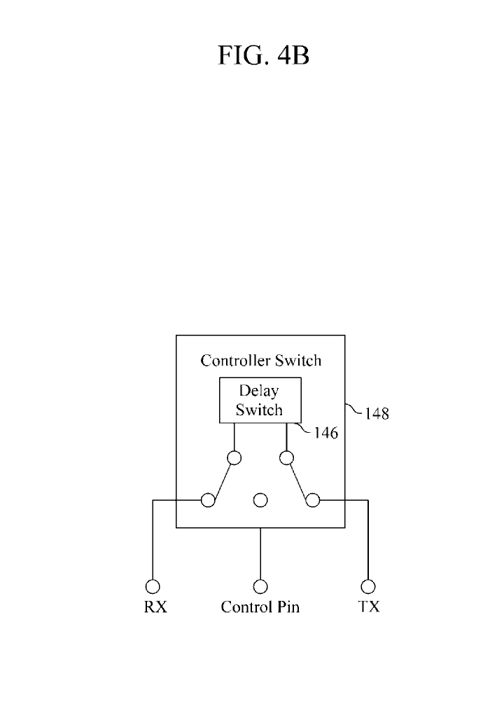

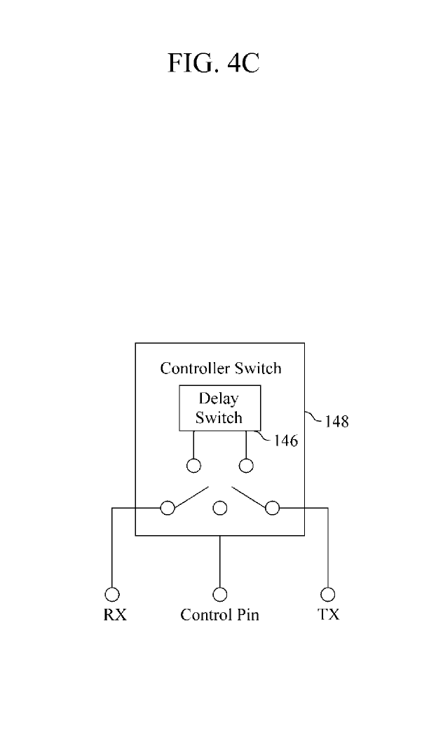

FIG. 4A, FIG. 4B and FIG. 4C are diagrams illustrating a configuration and operation of a controller switch of an NFC antenna in an NFC unit according to exemplary embodiments. FIG. 4A illustrates a control switch when the mobile NFC-enabled device operates in reader/writer mode or peer-to-peer mode according to exemplary embodiments, for example, with the NFC antenna 142 in the NFC unit 140 of FIG. 3. FIG. 4B and FIG. 4C illustrate control switches when the mobile NFC-enabled device operates in CE mode according to exemplary embodiments.

The delay switch 146 is only an example in FIGS. 4A to 4C. Reference characters “Rx” in FIGS. 4A to 4C represents a receiving end of the transceiver 144 (refer to FIG. 3), and “Tx” represents a transmitting end. In addition, a control pin is a pin to control the operation of the controller switch 148, and may be electrically connected to the main chip 11a (refer to FIG. 3).

Referring to FIGS. 4A to 4C, the operation of the controller switch 148 including the delay switch 146 may be controlled by the main chip 11a (refer to FIG. 3) that is connected to the control pin. When the mobile NFC-enabled device operates in reader/writer mode or peer-to-peer mode, the controller switch 148 may be set in a form of an existing NFC antenna by the control pin. In this case, the delay switch 148 does not need to operate because the delay switch 148 may cause an erroneous operation in reader/writer mode and the like.

Hence, the delay switch 146 operates only in CE mode (refer to FIGS. 4B and 4C), being controlled by the control pin to be ON state (refer to FIG. 4B) or OFF state (refer to FIG. 4C). When the mobile NFC-enabled device operates in CE mode, for example, when an induced current flows in the NFC antenna due to a magnetic field from the NFC reader, the delay switch 146 may enter in ON state under the control of the control pin, as shown in FIG. 4B. In addition, the delay switch 146 may remain in OFF state for a delay period, as shown in FIG. 4B, and then enter back in ON state as shown in FIG. 4B. By adding such delay switch 146 with the above configuration and operation to the existing NFC antenna, an induced current can be updated or newly sensed even when the mobile NFC-enable device stays at the same position close to the NFC reader, without needing to move the mobile NFC-enabled device, so that the mobile NFC-enabled device can operate as if it were moved away from the NFC reader and moved back close to the NFC reader.

Referring back to FIG. 2, the management unit 111 may provide a user interface (UI) through the input/output unit to allow the user to interact with the mobile NFC-enabled device in CE mode.

For example, the management unit 111 may display a plurality of NFC tags on a display such that the user can select an NFC tag to be loaded into the SE domain 130. The plurality of NFC tags, without limitation, may include NFC tags present in the storage unit 13, pre-registered NFC tags for use in CE mode operation, and extracted NFC tags. The criteria for the NFC tag extract will be described in detail later.

In addition, the management unit 111 may provide a UI via the input/output unit 12 that is used to register one or more NFC tags for use in CE mode operation of the mobile NFC-enabled device 10. The user may select one or more from the NFC tags (e.g., NFC tags installed in the mobile NFC-enabled device 10 by the user) present in the storage unit 13. The selected NFC tags may be stored in a list, and used in the CE mode operation. In this case, the management unit 111 may not use all NFC tags present in the storage unit 13 to operate in CE mode, but may only use NFC tags registered by the user to operate in CE mode. Thus, an NFC tag to be loaded into the SE domain 130 by the management unit 111 is one of registered NFC tags, and unregistered NFC tags, which although present in the storage unit 13, cannot be loaded into the SE domain 130.

In one example, the management unit 111 may provide a UI via the input/output unit 12 to be used to prioritize the registered NFC tags. The user may prioritize the registered NFC tags using the UI. The management unit 111 may load the selected NFC tags one by one into the SE domain 130 according to the priorities given to the NFC tags. The selection unit 112 may select an NFC tag to be loaded into the SE domain from among the registered NFC tags 130 according to the priority.

The management unit 111 may provide a UI via the input/output unit 12 to be used to set a selection condition for each of the registered NFC tags. The user may set the selection condition for each of the registered NFC tags using the UI. The management unit 111 may load the NFC tag that meets the selection condition into the SE domain 130. The collection unit 114 may collect selection information and the selection unit 112 may select an NFC tag from among the registered NFC tags as the NFC tag to be loaded into the SE domain 130 when the selection condition that meets the collected selection information is set for the NFC tag.

Data or information acquired by the mobile NFC-enabled device 10 may be used as the selection information and/or the selection condition, and the types of data or information are not limited. For example, the selection information and/or the selection condition may include location information, motion information, image information, time information, and the like. In addition, there may be set one selection condition or a number of selection conditions associated with one NFC tag. Regardless of the type of information to be used as selection information, the selection unit 112 may select an NFC tag meeting a selection condition as an NFC tag to be loaded into the SE domain, based on the selection information.

The location information that indicates a current location of the mobile NFC-enabled device 10 is obtained by a GPS equipped in the mobile NFC-enabled device 10, or based on a location of a found base station or a location of an accessible wireless LAN access point. For example, if the user frequently uses a particular NFC tag at a specific location (e.g., a certain company, a library, a subway station, or an amusement center), the user may define location information of that location as a selection condition for the NFC tag.

The motion information indicates a motion of the user that uses the mobile NFC-enabled device 10, and may be obtained by a gravity sensor, an acceleration sensor, a motion sensor (for example, a gyro sensor), or the like included in the mobile NFC-enabled device 10. For example, if there is relevance between a user's specific motion and an NFC tag, or relevance between the specific motion and a symbol associated with the NFC tag, the motion may be set as the selection condition for the NFC tag. In exemplary embodiments, the user may manually set motion information as a selection condition for each NFC tag.

The image information may be a picture or the like acquired, for example, by the camera unit 16 of the mobile NFC-enabled device 10. For example, if a particular image (e.g., a symbol of a credit card, a bus or subway image, a company ID image, a membership card image, an image or symbol of a building, or an image or a symbol of an NFC reader) is relevant to an NFC tag, the user may set the image as the selection condition for the relevant NFC tag.

The time information may indicate current time information offered by the mobile NFC-enabled device 10. For example, if the user uses a particular NFC tag at a specific time or day (e.g., a specific time of day to use a bus or subway to commute, usual time to clock in and out at work, a time to go to gym, a usual time to pay for a dinner, and the like), the user may set the time information about the time or day as a selection condition for the NFC.

The selection unit 112 may select one NFC tag to be loaded into the SE domain 130 from among one or more NFC tags. When the management unit 111 loads a plurality of NFC tags into the SE domain 130 one by one, the selection unit 112 may also select the NFC tag to be loaded into the SE domain 130 one by one. In this case, the selection unit 112 may use a round robin scheme to avoid the same NFC tag from being selected more than once.

The “one or more NFC tags” from which the selection unit 112 selects the NFC tag to be loaded into the SE domain 130 may be the NFC tags present in the storage unit 13 or the NFC tags registered by the user via the UI. In exemplary embodiments, the “one or more NFC tags” may be some NFC tags extracted from those present in the storage unit 13 or those registered by the user via the UI. The selection unit 112 may select the NFC tag to be loaded into the SE domain one by one from the “one or more NFC tags” randomly or in accordance with a criterion.

In exemplary embodiments, the selection unit 112 may select the NFC tag to be loaded into the SE domain 130 according to the priority given to each of the registered NFC tags. For example, the selection unit 112 may select the NFC tag to be loaded into the SE domain in sequence according to the priority.

The selection unit 112 may select the NFC tag to be loaded into the SE domain 130 based on information collected by the collection unit 114. For example, the selection unit 112 may select an NFC tag whose selection condition matches with the selection information collected by the collection unit 114, that is, the location information, the motion information, the image information, and time information. When there are a number of NFC tags whose selection conditions correspond to the selection information, the selection unit 12 may arbitrarily select the NFC tags using, for example, a round robin scheme. However, if the management unit 111 displays the plurality of NFC tags whose selection conditions correspond to the selection information through the UI, the user may select the NFC tag manually through the UI, and the selected NFC tag may be loaded into the SE domain, as described above.

The selection unit 112 may select an NFC tag to be loaded into the SE domain 130 from among the one or more NFC tags based on information about a user's NFC tag usage history recorded for a predetermined length of time, for example, a day, a week, or a month. The user's NFC tag usage history accumulated for a length of time may be stored in the storage unit 13. The NFC tag usage history includes at least a timestamp, one or more of time information about a time, a day and/or a date and a location information about a location where to use the NFC tag. The selection unit 112 may select an NFC tag to be loaded into the SE domain when a usage history of the NFC tag corresponds to the time and location where a magnetic field from the NFC reader is detected, that is, the time information or location information collected by the collection unit 114.

Referring back to FIG. 2, the extraction unit 113 may select one or more NFC tags that meet a criterion, from among the NFC tags present in the storage unit 13 or registered by the user. From among the one or more NFC tags selected by the extraction unit 113, the selection unit 112 may select an NFC tag to be loaded into the SE domain 130, or the one or more NFC tags may be displayed through the UI for the user to select one NFC tag therefrom. The extraction unit 113 may not be needed when the selection unit 112 selects the NFC tag from all NFC tags present in the storage unit 13, when the selection unit 112 selects the NFC tag from the NFC tags previously registered by the user, or when the management unit 111 displays a number of NFC tags through the UI according to other requirements. Thus, the extraction unit 113 may be an optional element. For example, the extraction unit 113 may be provided by the selection unit 112 or the management unit 111, and in this case, the extraction unit 113 may be provided by the selection unit 112 or the management unit 111.

In exemplary embodiments, the extraction unit 113 may select an NFC tag based on a type of the NFC reader. The extraction unit 113 may only extract an NFC tag that matches the type of the NFC reader from the NFC tags present in the storage unit 13 or registered by the user. Aspects of the invention are not limited to a method of the extraction unit 113 to identify the type of the NFC reader, such that the extraction unit 113 may use predefined information to identify the type of the NFC reader based on a currently applied NFC standard or a future NFC standard.

According to the present NFC standard, the type of an NFC reader may include proximity coupling device (PCD)-A, PCD-B, and vicinity coupling device. PCD conforms to international standardization organization (ISO) 14443, and VCD conforms to ISO 15693. PCD and VCD may be distinguished from each other by whether a magnetic field generated from the NFC reader contains Req type information. PCD has a magnetic field containing Req type information, whereas VCD has a magnetic field containing no Req type information. PCD is classified into PCD-A and PCD-B types, which are distinguished by, for example, a Req type value contained in a magnetic field. In addition, the NFC tags may be classified into different types, such as, PCD-A, PCD-B and VCD, corresponding to the types of the NFC reader, and thus it is possible to selectively extract an NFC tag according to information about a type of the NFC tag.

The collection unit 114 may collect information required for the operation of the CE mode operation unit 110. The collection unit 114 may collect a diversity of information, for example, location information, motion information, image information, and time information, required by the selection unit 112 in order to select an NFC tag to be loaded into the SE domain 130. In addition, the collection unit 114 may utilize various units included in the mobile NFC-enabled device 10 (refer to FIG. 1). Then, the collection unit 114 may determine whether the information required for the operation of the extraction unit 113, that is, information about whether a magnetic field contains Req type information, and if the Req type information is contained in the magnetic field, the collection unit 114 may identify a Req type value. Further, the collection unit 114 may collect information about a usage history of each NFC tag, for example, information on duration of use or on location of use.

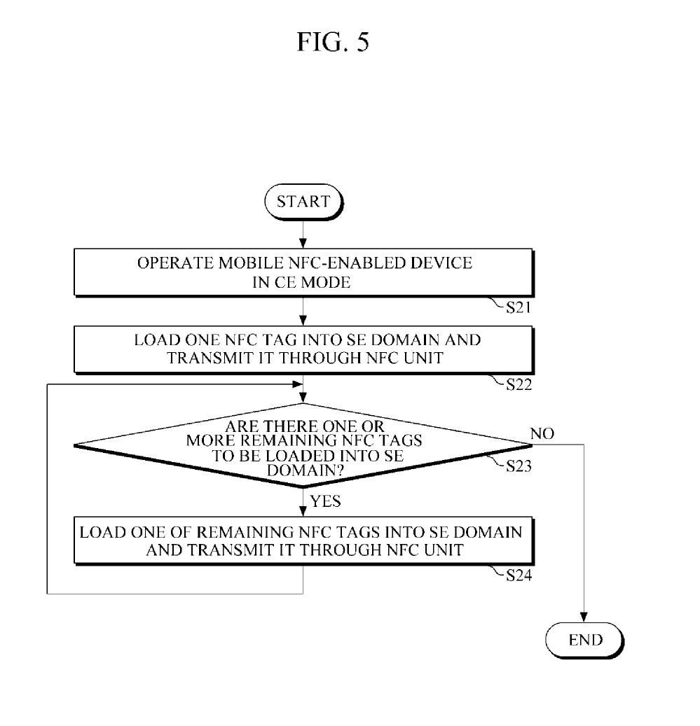

A method for operating a mobile NFC-enabled device according to exemplary embodiments of the present invention will be described with reference to FIG. 1 and FIG. 5. FIG. 5 illustrates a method to operate a mobile NFC-enabled device according to exemplary embodiments of the present invention. An example shown in FIG. 5 is directed to a case where the mobile NFC-enabled device, which may store a number of pieces of NFC tag data or which may be able to communicate with an NFC reader, operates in CE mode. The method of FIG. 5 may be implemented by the mobile NFC-enabled device 10 including the CE mode operation unit 110 as illustrated in FIG. 1, FIG. 2, FIG. 3, FIG. 4A, FIG. 4B and FIG. 4C. Hence, the operation method of the mobile NFC-enabled device will be briefly described, and the same operations as described in FIG. 1, FIG. 2, FIG. 3, FIG. 4A, FIG. 4B and FIG. 4C will not be reiterated.

Referring to FIG. 1 and FIG. 5, first, the mobile NFC-enabled device 10 is initiated to operate in CE mode in S21. In S21, aspects of the invention are not limited to a particular method for initiating the mobile NFC-enabled device 10 in CE mode. For example, in response to a magnetic field from the NFC reader being detected by the NFC unit 140, the mobile NFC-enabled device may automatically operate in CE mode. In this case, to initiate operation S21, it may be prerequisite that the mobile NFC-enabled device approaches the NFC reader to within a distance that is close enough to detect a magnetic field from the NFC reader.

In operation S21, the mobile NFC-enabled device 10 may be operated in CE mode by the user executing CE mode through a given UI. For example, a program or an application to operate the mobile NFC-enabled device 10 in CE mode may be installed in the mobile NFC-enabled device 10, and operation S21 may be performed in response to the user executing the program or application. In this case, the NFC unit's detecting the magnetic field from the NFC reader may be prerequisite for operation S22 (in which the NFC tag is loaded into the SE domain) to be executed in the mobile NFC-enabled device 10.

Then, the CE mode operation unit 110 of the mobile NFC-enabled device 10 may load one NFC tag into the SE domain 130, and transmit it to the external device through the NFC unit 140 in S22. The CE mode operation unit 110 may select the one NFC tag from among all or some of the NFC tags present in the storage unit 13.

In exemplary embodiments, the CE mode operation unit 110 may select one NFC tag using, for example, a round robin scheme from among NFC tags registered by the user, or select one NFC tag that meets a given selection condition (e.g., a given priority, location information, motion information, image information, time information, and information on NFC usage history). To this end, before operation S21, the CE mode operation unit 110 may provide a UI through the input/output unit 12 to allow the user to register NFC tags to be used from among the NFC tags present in the storage unit 13, and then the NFC tags selected by the user through the UI may be registered previously. In addition, prior to operation S21, the CE mode operation unit 110 may provide a UI through the input/output unit 12 to set a priority to each of the registered NFC tags, and load the NFC tag selected according to the priority given through the UI into the SE domain 130. In addition, prior to operation S21, the CE mode operation unit 110 may provide a UI through the input/output unit in an effort to set a selection condition for each of the registered NFC tags. The selection condition for each of the registered NFC tags may be set using the UI. The CE mode operation unit 110 may select an NFC tag whose selection condition matches with any of selection information collected by various modules of the mobile NFC-enabled device and load it into the SE domain 130.

In exemplary embodiments, in operation S22, an NFC tag selected by the user from a number of NFC tags displayed through the UI may be loaded into the SE domain 130. The CE mode operation unit 110 may provide a UI to allow the user to choose one NFC tag from a number of NFC tags that meets the predetermined criteria. In some examples, once the NFC tag chosen by the user is loaded into the SE domain 130 and transmitted in operation S22, the flow may not proceed any further.

Then, in operation S23, it is determined whether there are one or more remaining NFC tags to be loaded into the SE domain 130. The remaining NFC tag may indicate an NFC tag to be selected next according to the same method used to select the NFC tag to be loaded into the SE domain 130 in S22. In one example, operations subsequent to operation S23 may be performed regardless of whether the NFC reader successfully reads the NFC tag transmitted in operation S22. However, when the user intentionally stops the operations following operation S23 or when the mobile NFC-enabled device 10 fails to detect the magnetic field from the NFC reader because it is moved away from the NFC reader, the operations subsequent to operation S23 may not be performed.

The operations subsequent to operation S23 may be carried out when the mobile NFC-enabled device 10 is able to detect or continuously detect the magnetic field from the NFC reader. That is, the user may not need to move the mobile NFC-enabled device 10 away from the NFC reader and move it back to the NFC reader again in an effort to cause the operations subsequent to operation S23 to be performed. This effect may be implemented by various methods, and in one example, a delay switch may be added to an NFC antenna to update an induced current flowing through the NFC antenna at predetermined time intervals (refer to FIG. 3, FIG. 4A, FIG. 4B and FIG. 4C).

In response to a determination being made that there are remaining NFC tags in operation S23, the CE mode operation unit 110 may load one selected from the remaining NFC tags into the SE domain 130 and transmits the selected NFC tag to the external device through the NFC unit 140 in operation S24. In operation S24, the NFC tag secondly selected according to the same method as used to select the NFC tag in operation S22 may be loaded into the SE domain 130 in operation S24. Once operation S24 is performed, the flow returns to operation S23. If it is determined that there is no remaining NFC tag in operation S23, procedures for performing CE mode operation are terminated.

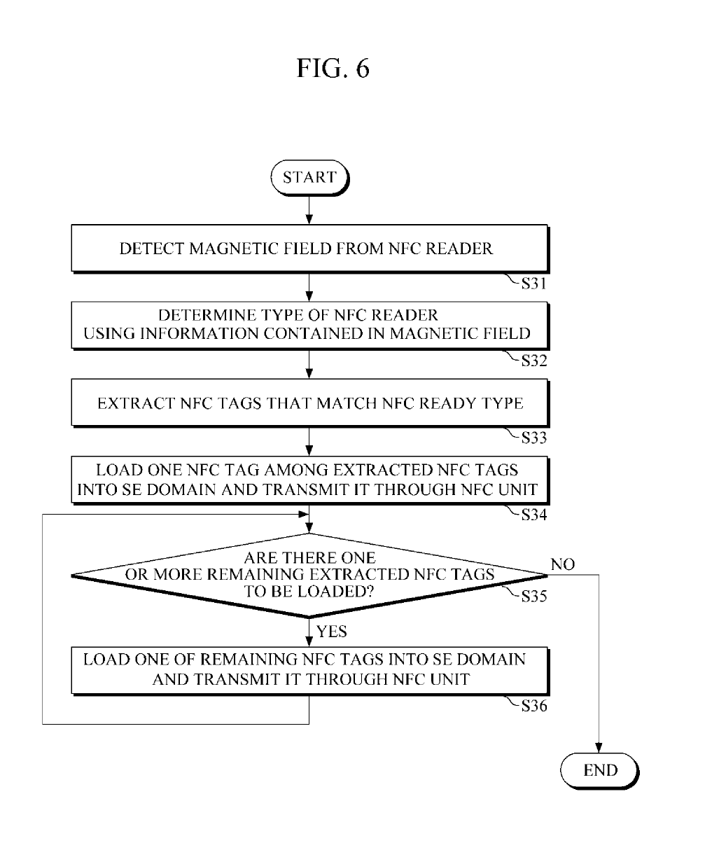

A method for operating a mobile NFC-enabled device according to exemplary embodiments of the present invention will be described with reference to FIG. 1 and FIG. 6. FIG. 6 illustrates a method to operate a mobile NFC-enabled device according to exemplary embodiments of the present invention. The method illustrated in FIG. 6 is directed to a mobile NFC-enabled device capable of storing a number of pieces of NFC tag data and communicating with an NFC reader operates in CE mode. The operation method of FIG. 6 may be implemented by the mobile NFC-enabled device 10 including the CE mode operation unit 110 as described with reference to FIG. 1, FIG. 2, FIG. 3, FIG. 4A, FIG. 4B and FIG. 4C. Thus, the operation method of the mobile NFC-enabled device will be briefly described, and the same operations as those described with reference with FIG. 1, FIG. 2, FIG. 3, FIG. 4A, FIG. 4B and FIG. 4C will not be reiterated. Hereinafter, differences from the operation method illustrated in FIG. 5 will be mainly described, and the descriptions omitted hereinafter may be the same as those described above with reference to FIG. 5.

Referring to FIGS. 1 and 6, the mobile NFC-enabled device 10 first detects a magnetic field generated from the NFC reader in operation S31. This operation S31 is an exemplary operation to initiate the mobile NFC-enabled device 10 to operate in CE mode. The mobile NFC-enabled device 10 that detects the magnetic field through the NFC unit 140 may automatically start operating in CE mode. For the automatic start, it may be prerequisite that the user moves the mobile NFC-enabled device 10 toward the NFC reader within a distance close enough for the mobile NFC-enabled device to detect the magnetic field from the NFC reader. In operation S31, the mobile NFC-enabled device 10 may operate in CE mode by executing CE mode using a given UI equipped in the mobile NFC-enabled device 10. The detection of the magnetic field from the NFC reader may be a prerequisite for performing operations (determination of a type of the NFC reader and loading of the NFC tag into the SE domain) following operation S32.

The mobile NFC-enabled device 10 that detects the magnetic field in operation S31 identifies a type of the NFC reader using information contained in the magnetic field in operation S32. For example, the mobile NFC-enabled device 10 may determine whether the NFC reader is of PCD type or VCD type according to whether the detected magnetic field contains Req type information. In response to a determination being made that the magnetic field contains Req type information, the mobile NFC-enabled device 10 may determine whether the NFC reader is of PCD-A type or PCD-B type using a Req type value. As such, by preliminarily determining the type of the NFC reader, not all NFC tags are to be loaded into the SE domain in the subsequent operations S34 and S36, but only the NFC tags that match the type of the NFC reader are to be loaded into the SE domain, thereby performing the CE mode operation efficiently.

In operation S33, the CE mode operation unit 110 extracts an NFC tag that matches with the type of the NFC reader, which has been identified in operation S32. The CE mode operation unit 110 may extract the NFC tag that matches with the type of the NFC reader from all NFC tags present in the storage unit 13. The CE mode operation unit 110 may extract the NFC tag from only the NFC tags that has been registered by the user. To this end, each of the NFC tags may contain information about a type of an NFC reader that matches with the NFC tag or the CE mode operation unit 110 may determine by itself a type of each of the stored or registered NFC tags using a given algorithm.

Then, the CE mode operation unit 110 of the mobile NFC-enabled device 10 loads one of the extracted NFC tags into the SE domain 130, and transmits the extracted NFC tag to the external device through the NFC unit 140 in operation S34.

At this time, the CE mode operation unit 110 may select an NFC tag from the extracted NFC tags using, for example, a round robin scheme or based on a given selection condition (e.g., a given priority, location information, motion information, image information, time information, and information about an NFC usage history).

In operation S34, the user may select an NFC tag from a number of NFC tags displayed through the UI and the selected NFC tag may be loaded into the SE domain 130. The CE mode operation unit 110 may provide the UI to allow the user to select the NFC tag from the number of extracted NFC tags. In exemplary embodiments, when the NFC tag selected in operation S34 is loaded into the SE domain 130 and transmitted to the external device, subsequent operations may not be performed.

Then, in operation S35, it is determined whether any NFC tags remain to be loaded into the SE domain 130 among the NFC tags extracted in S33. Here, the remaining NFC tag may indicate an NFC tag to be selected next according to the same process that was used to select the NFC tag to be loaded into the SE domain 130 in operation S34. In one example, operations subsequent to operation S35 may be automatically performed regardless of whether the NFC reader successfully reads the NFC tag transmitted in S34. However, when the user intentionally stops the operations following operation S35 or when the mobile NFC-enabled device 10 fails to detect the magnetic field from the NFC reader because it is moved away from the NFC reader, the operations subsequent to operation S35 may not be performed.

In response to a determination being made that there are remaining NFC tags in operation S35, the CE mode operation unit 110 may load one selected from the remaining NFC tags into the SE domain 130 and transmit the selected NFC tag to the external device through the NFC unit 140 in operation S36. In operation S36, the NFC tag secondly selected according to the same process as used to select the NFC tag in operation S34 may be loaded into the SE domain 130 in S36. Once operation S36 is performed, the flow returns to operation S35. If it is determined that there is no remaining NFC tag in operation S35, procedures for performing CE mode operation are terminated.

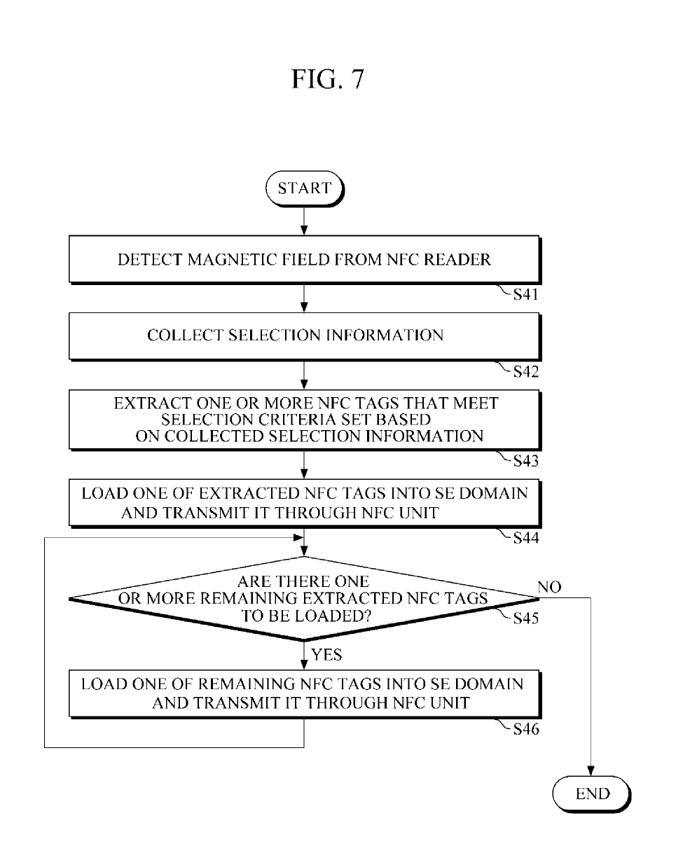

A method for operating a mobile NFC-enabled device according to exemplary embodiments of the present invention will be described with reference to FIG. 1 and FIG. 7. FIG. 7 illustrates a method of a mobile NFC-enabled device according to exemplary embodiments of the present invention. The method illustrated in FIG. 7 is directed to a mobile NFC-enabled device capable of storing a number of pieces of NFC tag data and communicating with an NFC reader operates in CE mode. The operation method of FIG. 7 may be implemented by the mobile NFC-enabled device 10 including the CE mode operation unit 110 as described with reference to FIG. 1, FIG. 2, FIG. 3, FIG. 4A, FIG. 4B and FIG. 4C. Thus, the operation method of the mobile NFC-enabled device will be briefly described, and the same operations as those described with reference with FIG. 1, FIG. 2, FIG. 3, FIG. 4A, FIG. 4B and FIG. 4C will not be reiterated. Hereinafter, differences from the operation methods illustrated in FIGS. 5 and 6 will be mainly described, and the descriptions omitted hereinafter may be the same as those described above with reference to FIG. 5 and FIG. 6.

Referring to FIG. 1 and FIG. 7, in operation S41, the mobile NFC-enabled device 10 detects a magnetic field generated from the NFC reader. This operation S41 is an exemplary operation to initiate the mobile NFC-enabled device 10 to operate in CE mode. The mobile NFC-enabled device 10 that detects the magnetic field through the NFC unit 140 may automatically start operating in CE mode. For the automatic start, it may be prerequisite that the user moves the mobile NFC-enabled device 10 toward the NFC reader within a distance close enough for the mobile NFC-enabled device to detect the magnetic field from the NFC reader.

Thereafter, the mobile NFC-enabled device 10 collects selection information in S42. The selection information may be data or information acquired by various operations of the mobile NFC-enabled device 10, and a type of information is not limited. For example, the selection information may include location information, motion information, image information, and time information. Further, the selection information may include information on a type of the NFC reader. The operations illustrated in FIG. 7 may be substantially the same as those illustrated in FIG. 6 if in operation S43 an NFC tag is extracted using only the selection information.

In operation S42, one or more pieces of selection information may be collected. Although operation S42 follows operation S41 in FIG. 7, the order of operations is provided only for exemplary purpose. That is, operation S42 may be performed prior to operation S41 and/or simultaneously with operation S41.

In operation S43, the CE mode operation unit 110 extracts one or more NFC tags that meet a selection condition that is defined using the collected selection information. The CE mode operation unit 110 may extract the NFC tags from all NFC tags present in the storage unit 13. In exemplary embodiments, the CE mode operation unit 110 may extract the NFC tags only from the NFC tags registered by the user. Hence, the CE mode operation unit 110 may include the selection condition in each of the NFC tags stored or registered.

Then, the CE mode operation unit 110 of the mobile NFC-enabled device 10 loads one of the extracted NFC tags into the SE domain 130, and transmits it to the external device through the NFC unit 140 in S44.

The CE mode operation unit 110 may select an NFC tag from the extracted NFC tags using, for example, a round robin scheme. In exemplary embodiments, in operation S44, the user may select an NFC tag from a number of NFC tags displayed through a UI and the selected NFC tag may be loaded into the SE domain 130. In this case, subsequent operations may not be performed.

In operation S45, it is determined whether any NFC tags remain to be loaded into the SE domain 130 among the NFC tags extracted in S43. The remaining NFC tag may indicate an NFC tag to be selected next according to the same process that was used to select the NFC tag to be loaded into the SE domain 130 in operation S44. In response to a determination being made that there are remaining NFC tags in operation S45, the CE mode operation unit 110 may load one selected from the remaining NFC tags into the SE domain 130 and transmits the selected tag to the external device through the NFC unit 140 in operation S46. Once operation S46 is performed, the flow returns to operation S45. If it is determined that there is no remaining NFC tag in operation S45, procedures for performing CE mode operation are terminated.

According to the exemplary embodiments of the present invention, the mobile NFC-enabled device detecting a magnetic field from an NFC reader selects one NFC tag from a number of NFC tags per a selection scheme, automatically loads the selected NFC tag into a particular domain, for example, a SE domain, and transmits the loaded NFC tag through the NFC unit to an external device. Accordingly, without user's pre-selection process (for example, selection of an NFC tag by executing an NFC tag-related application) through a UI, it is possible to enable the NFC reader to read an NFC tag. Also, without needing for the user to move away the mobile NFC-enabled device from the NFC reader and then move it back close to the initial location, it is possible to enable a number of NFC tags to be loaded one by one into the SE domain and to be transmitted through the NFC unit even when the mobile NFC-enabled device stays at the same location near the NFC reader.

In addition, it is possible to load an NFC tags selected in consideration of user's life pattern, environments or preferences, or based on a selection condition into the SE domain and transmit the loaded NFC tag to an external device, and thereby the user can efficiently select an NFC tag to use.

The methods and/or operations described above may be recorded or stored in one or more non-transitory computer-readable storage media that includes program instructions to be implemented by a computer to cause a processor to execute or perform the program instructions. The media may also include, alone or in combination with the program instructions, data files, data structures, and the like. Examples of computer-readable storage media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules in order to perform the operations and methods described above, or vice versa. In addition, a computer-readable storage medium may be distributed among computer systems connected through a network and computer-readable codes or program instructions may be stored and executed in a decentralized manner.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method comprising:
sensing an induced current in a Near Field Communication (NFC) antenna; and
blocking the induced current flow and releasing the induced current flow in the NFC antenna.

2. The method of claim 1, further comprising disposing an NFC device within range of the NFC antenna to induce the induced current, wherein the NFC device inducing the induced current remains within range for a duration.

3. The method of claim 1, further comprising:
collecting selection information; and
extracting NFC tags that meet a selection criteria based on the selection information.

4. The method of claim 1, further comprising loading a NFC tag after the sensing.

5. The method of claim 4, further comprising synchronizing the blocking and releasing of the induced current and the loading so that the NFC tag is loaded prior to the releasing of the induced current.

6. The method of claim 4, further comprising loading another NFC tag after the blocking and releasing of the induced current.

7. The method of claim 4, further comprising transmitting the NFC tag through an NFC unit.

8. The method of claim 4, wherein the NFC tag is loaded into a Secure Element (SE) domain or a Universal Subscriber Identity Module (USIM).

9. The method of claim 1, further comprising disconnecting a delay switch when operating NFC unit in a Card Emulation (CE) domain.

10. A Near Field Communication (NFC)-enabled device comprising:
an NFC antenna configured to sense an induced current therein; and
a delay switch configured to start and stop the flow of the induced current in the NFC antenna.

11. The device of claim 10, wherein a second NFC device is disposed within range of the NFC antenna to induce the induced current, wherein the NFC device inducing the induced current remains within range for a duration.

12. The device of claim 10, further comprising:
a collection unit configured to collect selection information; and
an extraction unit configured to extract NFC tags that meet a selection criteria based on the selection information.

13. The device of claim 10, further comprising a Card Emulation (CE) mode operation unit configured to load an NFC tag.

14. The device of claim 13, wherein the CE mode operation unit is configured to synchronize the start and stop of the induced current so that the NFC tag is loaded prior to the induced current being started.

15. The device of claim 13, wherein the CE mode operation unit is configured to resume the load of the NFC tag after an interruption in the sensing of the induced current for a small interval.

16. The device of claim 13, wherein the CE mode operation unit is configured to transmit the NFC tag through an NFC unit.

17. The device of claim 13, further comprising a Secure Element (SE) domain storage, wherein the CE mode operation unit is configured to load the NFC tag into the SE domain storage.

18. The device of claim 13, further comprising a Universal Subscriber Identity Module (USIM), wherein the CE mode operation unit is configured to store the NFC tag in the USIM.

19. A method comprising:
disposing an NFC device within range of a Near Field Communication (NFC) antenna and inducing a current in the NFC antenna;
loading a selected tag from a plurality of NFC tags; and
transferring the selected tag via the NFC antenna from the NFC device while the NFC device continuously remains in range of the NFC antenna by temporarily blocking the induced current flow and releasing the induced current flow.

20. The method of claim 19, wherein the loading comprises loading multiple selected tags from the plurality of NFC tags.
